(19) United States
(12) Patent Application Publication
(10) Pub. No.: US 2009/0246322 A1
(43) Pub. Date: Oct. 1, 2009

(54) TRACE MINERAL-INFUSED BEVERAGE TO PROVIDE INCREASED ATHLETIC PERFORMANCE, LONG-LASTING ENERGY, AND HEALTH BENEFITS

(76) Inventor: John David Lincoln, Long Beach, CA (US)

Correspondence Address: John Lincoln, Ph.D., 8121 Marina Pacifica Dr. North, Long Beach, CA, 90803, US

(21) Appl. No.: 12/372,740

(22) Filed: Feb. 18, 2009

Related U.S. Application Data
(60) Provisional application No. 61/068,291, filed on Mar. 6, 2008.

(51) Int. Cl. A23L 2/52; A23L 2/38; A23L 2/56; A23L 2/58; A23L 2/68

(52) U.S. Cl. 426/66

(57) ABSTRACT

The present invention relates to beverage compositions prepared using a solution of ionic trace minerals whose presence, in combination with other ingredients, provides long-lasting energy, immediate nutritional health benefits, and improved athletic performance to humans or other mammals during strenuous exercise.

### FIELD OF THE INVENTION

The present invention relates to beverage compositions prepared using a solution of ionic trace minerals to be used primarily for enhanced athletic performance.

### BACKGROUND OF THE INVENTION

In the present invention, ionic trace minerals collected and purified from inland seas or other saline water bodies are provided in a beverage to help supplement mineral deficiencies, particularly for athletes, whose nutritional deficits may become more extreme during strenuous exercise due to sweat loss [Chinevere et al, 2007] [Lo et al, 1965] [Lukaski et al, 2000]. Scientific literature is rich with information demonstrating that these trace minerals are critical to the many biochemical pathways operating in a healthy body. The aforementioned trace minerals may be delivered in a beverage in combination with other active and inactive ingredients for the potential of the composition to be realized. It is well-understood both in the art and in modern science that the effects of strenuous physical activity may be mitigated using beverages whose role it is to improve hydration through the use of carbohydrates and electrolytes [U.S. Pat. Nos. 4,874,606, 4,981,687, 5,089,477, 6,989,171]. Further inventions addressing cellular nutritional needs are presented in U.S. Pat. Nos. 5,114,723 and 5,147,650. The present invention brings the additional aspect of infusing ionic trace minerals, whose benefits are, in addition, supplemented by the benefits of other active ingredients including cyanocobalamin [vitamin B12], ascorbic acid [vitamin C], guarana, green tea extract, carbohydrates [in the form of fructose, glucose, sucrose, or combinations thereof], and electrolytes [those containing in ionic form sodium, potassium, or magnesium ions]. Prior art beverages [e.g. Gatorade®, Powerade®, Propel Fitness Water™] have not comprehensively addressed the nutritional deficiencies of trace minerals caused by strenuous exercise, nor have they addressed the benefits of doing so. The combination of both ionic trace minerals and the ingredients listed in the present invention speak to these issues, providing an immediate burst of energy, sense of well-being, and mental clarity that helps subjects reach their full physical potential while at the same time remaining healthy and hydrated.

The beverage of the present invention may be generally compounded with water, bottled, and stored. Blending may be accomplished by individually adding ingredients to a mixing container and agitating for approximately 1 hour at 10° C. Alternatively, all of the components except water may be prepared in advance as a concentrate for ease of handling and transportation. The resolvation of ionic minerals do not reduce their efficacy, as they are water-soluble. The beverage may also be prepared with carbonation should this become desirable.

### SUMMARY OF THE INVENTION

The subject invention relates to a liquid composition comprising:
a. From about 0.01 to 1.0% of a saturated ionic trace mineral solution
b. From about 0.5% to 25% of a fructose, glucose, or sucrose, or a combination thereof comprising the same
c. From about 0.01% to 0.3% of additional sodium ions
d. Water
e. Guarana: 0.001-0.10%
f. Vitamin B12: 0.0001-0.1%
g. Green Tea Extract: 0.001-0.5%
h. Ascorbic Acid: 0.01-1.0%
i. Natural Flavoring: 0.01-10%
j. Citric Acid: 0.05-5.0%
k. Natural Coloring: 0.01-5.0%

### DETAILED DESCRIPTION

### Definitions

As used herein, the term “comprising” means various components can be conjointly employed in the beverages of this invention. The terms “consisting of” and “comprised of” are embodied in the term comprising.

As used herein, the term “beverage composition” means a composition that is single strength and ready to drink.

As used herein, the term “trace minerals” refers to a saturated solution of ionic trace minerals collected and refined from the Great Salt Lake in Utah. Without restriction, an elemental analysis is presented in Table 1.

As used herein, the term “green tea extract” refers to teas which include materials, for instance, such as freshly gathered tea leaves, fresh tea leaves that are dried immediately after gathering, or these materials otherwise modified and refined to polyphenols of green teas.

All percentages herein are by weight unless otherwise specified.

### Beverage Composition:

When administered, beverage compositions of the present invention result in enhanced athletic performance, as well as provide health benefits and long-lasting energy. Specific ingredients play both independent and composite roles in the causation of these results.

Ionic Trace Minerals: The dominant and key ingredients in the present invention are its minerals. Mammals ultimately rely on the earth for nutrition. Whether by consumption of water, fruits and vegetables, or animal-based products, the basic elements that build our bodies come from the soil in the earth. With the emergence of industrialized society, the soil from which food is grown has been depleted of many of its naturally occurring vitamins and minerals due to the overuse of soils for agricultural purposes. Minerals and elements that might normally be found in soils and in turn in food are no longer present. In the present invention, ionic trace minerals collected and purified from the Great Salt Lake in Utah are added to help supplement this deficiency, which may become more extreme during strenuous exercise due to sweat loss. Scientific literature is rich with information demonstrating that trace minerals may be lost during exercise. Specific mineral functions for trace minerals are described in Table 2. While other minerals are likely to be present in this invention, those with both a probable or proven role in the human body and a significant concentration in the invention are itemized here. Supplementation with these minerals promotes the complete and healthy functioning of countless critical biological pathways, many of which have not yet been researched and are not well-understood in modern science. The fact that these minerals are ionic in the present invention [charged] rather than colloidal [uncharged, stable in suspension], promotes rapid transport across cellular membranes and therefore immediate absorption. The absorption rate of vitamins and minerals being a direct factor in the rate of their effect in the body, the present invention delivers a quick and lasting energy and liveliness.

Carbohydrates: In the present invention, carbohydrates are used as a sweetener, and as an accelerator for absorption in the digestive system. During exercise, carbohydrates are burned by the body for energy in the form of glucose. It is therefore necessary to supplement the body's depleted levels of carbohydrates, especially for endurance athletes. With respect to bodily absorption, numerous studies indicate that the absorption of water through the small intestine may be accelerated with a solution of sugars and electrolytes. Most studies indicate that water can be absorbed from healthy small intestines at rates ranging from 0.4 l/h to 0.9 l/h when 2-8% carbohydrate-electrolyte solutions are repeatedly ingested during either rest or moderate intensity exercise [Driskoll & Wolinksy, 2000]. Maximum absorption rates are common to more dehydrated subjects ingesting 6-8% solutions. It is thought that the average athlete will benefit from a healthy blend of carbohydrates and nutrients rather than the sugar spike common to other sports beverages, which increases insulin release and may result in weight gain for non-endurance athletes.

Sodium Ions Sodium is a dietary mineral essential to life. As one the primary electrolyte in the body, sodium is responsible for the maintenance of osmotic gradients in cells, as well as the exchange between intracellular and extracellular nutrients. Doctors and scientists strongly agree that sweating, caused by high body temperatures and/or long term exercise, may lead to sodium deficiencies in the human body. The immediate effects of this are dizziness and muscle cramps. While it is now agreed upon by researchers that it is unnecessary to replace sodium during short-term exercise [less than 2 hours], the present invention contains this ingredient to reduce the likelihood of occurrence of the aforementioned effects. The electrolyte is present to help provide a baseline concentration, if the body needs it, and promote increased absorption rates in the small intestine.

Guarana: Guarana is a shrub native to the Amazon, where it has historically been used in much the same way as chocolate to prepare various foods, drinks and medicines. Today, powdered guarana seed is known and used worldwide as an ingredient in nutraceutical beverages for its thermogenic and energizing effects. Guarana supplementation is reported to increase mental alertness, fight fatigue, and increase stamina and physical endurance. Presently, guarana is taken daily as a health tonic by millions of South Americans who believe it helps to overcome heat fatigue, combats premature aging, detoxifies the blood, and is useful in the prevention of obesity, dyspepsia, fatigue, and for arteriosclerosis. While South Americans have been using guarana for centuries, western research has begun to verify that the indigenous uses are well-grounded in science. There is little toxicological risk associated with guarana, as animal studies have shown the seed is non-toxic at even high dosages of up to 2 grams per kilogram of body weight [Mattei, 1998].

Vitamin B12: Vitamin B12 [cyanocobalmin] is a critical nutrient that acts to, among other compounds, facilitate chemical transport between oxygen and hemoglobin in the blood. It is therefore a critical vitamin and must be acquired through food. Taken often as a supplement, vitamin B12 can increase energy levels, athletic performance, metabolism, and overall awareness by increasing the oxygen content of our blood [Williams, 1989]. These are the primary reasons for its presence in the present invention. On the other hand, low levels of vitamin B12 have been associated with fatigue, asthma, depression, Alzheimer's, AIDS, multiple sclerosis, tinnitus, diabetic neuropathy and low sperm counts. Clearly, it is very important to maintain adequate body stores of this crucial vitamin. The amount of vitamin B12 actually needed by the body is very small, probably only about 2 micrograms or 2 millionth of a gram/day. Unfortunately, vitamin B12 is not absorbed very well, so much larger amounts need to be supplied through the diet or supplementation. The richest dietary sources of vitamin B12 are liver, especially lamb's liver, and kidneys. Eggs, cheese and some species of fish also supply small amounts, but vegetables and fruits are generally poor sources. Several surveys have shown that most strict, long-term vegetarians are vitamin B 12 deficient. Oral supplementation with vitamin B12 is safe, efficient and inexpensive. Most multi-vitamin pills contain 100-200 microgram [mcg] of the cyanocobalamin form of B-12. The present invention contains approximately 100 mcg per serving. As vitamin B12 is water soluble, its presence in solution accelerates absorption, increasing the delivery rate for a more immediate effect.

Green Tea Extract: Green Tea is popular for its widespread medicinal benefits, it being used to treat everything from headaches to depression. Today, scientific research in both Asia and the west is providing hard evidence for the health benefits long associated with drinking green tea. For example, research indicates that green tea consumption is associated with reduced instances of cardiovascular and liver disease [Imai & Nakachi, 1995] and cancer [Fujiki, 2005]. There is also research indicating that drinking green tea lowers total cholesterol levels, as well as improving the ratio of good [HDL] cholesterol to bad [LDL] cholesterol. The mechanism of green tea lies in the fact it is rich in polyphenols, particularly epigallocatechin gallate [EGCG]. EGCG is a powerful anti-oxidant: besides inhibiting the growth of cancer cells, it kills cancer cells without harming healthy tissue. It has also been effective in lowering LDL cholesterol levels, and inhibiting the abnormal formation of blood clots, which are leading causes of cardiovascular disease. The present invention uses a blend of green tea extract to promote these health effects.

Vitamin C [Ascorbic Acid]: It has long been accepted that a diet rich in vitamin C provides protection against cancer and heart disease [Siehs & Stahl, 1995]. Other researchers have found that people who suffer from asthma, arthritis, cancer, diabetes, and heart disease have much lower levels of vitamin C in their blood than do healthy people [Will & Byers, 1996] [Jacobs, 1993] [Malins, 1996]. Vitamin C is a wonder nutrient and there is no doubt that many of the serious degenerative diseases plaguing the civilized world today can be prevented or even reversed through an adequate intake of this essential vitamin. The current US RDA for vitamin C is 90 mg/day, yet most researchers now agree that it is entirely safe even in daily quantities of 10 g or more. For these reasons, the present invention utilizes a health dose of vitamin C [approximately 290 mg/bottle or 300% the US RDA] as an integral part of the product.

Natural Flavoring Extracts from natural sources are used in the present invention to add refreshing flavor. These ingredients do not play a role in the function of the beverage, but rather are added to make drinking more enjoyable.

Citric Acid Citric acid is a colorless, crystalline organic compound common to citrus fruits. It is present in practically all plants and in many animal tissues and fluids. Biologically, it serves as one of a series of compounds involved in the processing of fats, proteins, and carbohydrates in the body. Citric acid is used in the present invention as a natural flavor, preservative, and pH adjustor.

Natural Coloring Colorant extracted from natural sources may be added to change the appearance of the beverage, giving it colored tint.

### Preferred Embodiments

The drinkable beverage composition may be prepared by mixing together all of the ingredients in any sequence such that water-soluble ingredients are added to water first, followed by insoluble ingredients (guarana and green tea extracts). The mixture is dissolved in the water and agitated with a mechanical stirrer until all of the ingredients have gone into solution with the exception of insoluble ingredients.

Example compositions of the present inventions are listed in Table 3. The following examples are given to illustrate the invention and are not intended to limit it in any way.

### Example I

One healthy individual runs a marathon [26.2 miles] with average race day temperature of 78° F. That individual consumes Gatorade® freely during the race up until mile 18, when the individual transitions to the composition present in Example I, offered by an assistant at both miles 18 and again at mile 21. The individual's average pace increases from 9:15 per mile to 8:50 per mile and holds steady for the remainder of the race. Perceived difficulty is also reported to have been reduced.

### Example II

Eight healthy, athletic individuals are provided with beverage composition II in Table 3 and asked to report both perceived difficulty as well as energy level on a normalized scale [1-10] during exercise over a 1 week period. Individuals report an average reduction in perceived difficulty of 25% and an average increase in energy level of 40%.

### Example III

Two healthy individuals are asked to run 1 mile at a leisurely pace, and are permitted to drink water freely following this exercise. They are then asked to run 1 mile at 75% effort. Following this mile they are allowed to drink beverage composition III freely. The individuals are again asked to run 1 mile at 75% pace. Pace times improve an average of 8 seconds per mile and overall perceived difficulty is diminished.

TABLE 1
Elemental analysis of the ionic trace mineral
ingredient in the present invention

| | | Concentration in Trace Mineral |
|---|---|---|
| | | Ingredient of Present Invention |
| Number | Mineral | (without limitation) Units are mg/l |
| 1 | Aluminum | 0.041 |
| 2 | Beryllium | 0.008 |
| 3 | Bismuth | 0.04 |
| 4 | Boron | 287 |
| 5 | Bromide | 1.88 |
| 6 | Calcium | 48.2 |
| 7 | Carbon | <78 |
| 8 | Cerium | 0.93 |
| 9 | Cesium | 0.266 |
| 10 | Chloride | 342390 |
| 11 | Chromium | 0.034 |
| 12 | Cobalt | 0.019 |
| 13 | Copper | 1.07 |
| 14 | Dysprosium | 0.41 |
| 15 | Europium | 0.005 |
| 16 | Fluorine | 2.88 |
| 17 | Gadolinium | 0.71 |
| 18 | Gallium | 0.311 |
| 19 | Gold | 0.02 |
| 20 | Holmium | 0.02 |
| 21 | Iodine | 5.21 |
| 22 | Iron | 0.26 |
| 23 | Lanthanum | 0.28 |
| 24 | Lutetium | 0.03 |
| 25 | Magnesium | 101450 |
| 26 | Manganese | 0.039 |
| 27 | Molybdenum | 0.011 |
| 28 | Nickel | 0.02 |
| 29 | Phosphorous | 0.1 |
| 30 | Potassium | 1100 |
| 31 | Praseodymium | 0.03 |
| 32 | Rubidium | 12.7 |
| 33 | Scandium | 0.01 |
| 34 | Selenium | 0.065 |
| 35 | Silica | 68.9 |
| 36 | Silver | 0.89 |
| 37 | Strontium | 0.247 |
| 38 | Sodium | 1920 |
| 39 | Terbium | 0.091 |
| 40 | Tin | 0.98 |
| 41 | Titanium | 0.071 |
| 42 | Vanadium | 212 |
| 43 | Tungsten | 0.01 |
| 44 | Zinc | 21.6 |

TABLE 2
Known bodily functions of selected trace minerals

| Number | Mineral | Role in Human Body |
|---|---|---|
| 1 | Aluminum | Active in enzymes used for porphyrin synthesis (in red blood cells). |
| 2 | Beryllium | No specific RDA. Biological functions unknown. |
| 3 | Bismuth | No specific RDA. Biological functions unknown. |
| 4 | Boron | No specific RDA. Biological functions unknown, although animal data |
| | | indicate a functional role. |
| 5 | Bromide | Probable essential trace mineral. Biological functions unknown, |
| | | although it is essentially for algae and some mammals. |
| 6 | Calcium | Muscle, digestive, and CNS health, builds bone and tooth enamel, |
| | | neutralizes acidity, clears toxins, helps blood stream. |
| 7 | Carbonate | In many of the body's key polyatomic ions, including bicarbonate, |
| | | which aids in digestion and combats fatigue. |
| 8 | Cerium | No specific RDA. Biological functions unknown. May stimulate |
| | | metabolism. |
| 9 | Cesium | No specific RDA. Biological functions unknown. |
| 10 | Chloride | For production of hydrochloric acid in the stomach. |
| 11 | Chromium | Implicated in sugar metabolism. Usesful in preventing and treating |
| | | high blood pressure. Deterrent for diabetes. |
| 12 | Cobalt | Required for biosynthesis of vitamin B12 and related coenzymes. Trace |
| | | amounts present in human body. |
| 13 | Copper | Anti-inflammatory. Protects against cardiovascular disease. Assists |
| | | absorption of iron. Active in enzyme metabolism. |
| 14 | Dysprosium | No specific RDA. Biological functions unknown. |
| 15 | Europium | No specific RDA. Biological functions unknown. |
| 16 | Fluorine | Plays a large role in bone and dental health. |
| 17 | Gadolinium | No specific RDA. Biological functions unknown. May stimulate |
| | | metabolism. |
| 18 | Gallium | No specific RDA. Biological functions unknown. May stimulate |
| | | metabolism. |
| 19 | Gold | Generally inert to body chemistry. Useful for treating arthitis. |
| 20 | Holmium | No specific RDA. Biological functions unknown. |
| 21 | Iodine | Required for the syntheis of throxin (for the thyroid). Improves mental |
| | | alertness. Promotes healthy hair, nails and skin. |
| 22 | Iron | Required for many proteins and enzymes, notably hemoglobin (in the |
| | | blood). Prevents anemia. |
| 23 | Lanthanum | No specific RDA. Biological functions unknown. |
| 24 | Lutetium | No specific RDA. Biological functions unknown. |
| 26 | Magnesium | Required for ATP and related reactions. Builds bone, increases |
| | | flexibility, increases alkalinity. |
| 27 | Manganese | Strong role in oxygen processing. Improves memory. Promotes |
| | | healthy muscle reflexes. Eliminates fatigue. |
| 27 | Nickel | Present in urease. May serve as cofactor of metalloenzymes and |
| | | facilitiate iron absorption. |
| 28 | Molybdenum | Required for xanthine oxidase and related oxidases. Helps prevent |
| | | cancer and anemia. |
| 29 | Phosphorous | Component of bones. Used in energy processing and many other |
| | | functions. Ph maintenance. Nucleotide synthesis. |
| 30 | Potassium | Electrolyte. Prevents high blood pressure. Helps dispose of body |
| | | wastes. Beneficial in the prevention of cancer. |
| 31 | Praseodymium | No specific RDA. Biological functions unknown. |
| 32 | Rubidium | No specific RDA. Biological functions unknown. |
| 33 | Scandium | No specific RDA. Biological functions unknown. |
| 34 | Selenium | Required for peroxidase. Anti-carcinogenic. Increases sex drive in |
| | | males. Immunostimulant. Anti-inflammatory. |
| 35 | Silicon | No specific RDA. Biological functions unknown. Involved in bone |
| | | functions in animal studies. |
| 36 | Silver | No specific RDA. No clear biological functions for the human body. |
| 37 | Strontium | Trace amounts found in the human body. No specific RDA. Biological |
| | | functions unknown. |
| 38 | Sodium | Electrolyte. Sodium is the main extracellular cation in mammals and is |
| | | critical for nerve function. |
| 39 | Terbium | No specific RDA. Biological functions unknown. |
| 40 | Tin | No specific RDA. Biological functions unknown. Required in trace |
| | | amounts for some animals. |
| 41 | Titanium | No specific RDA. Biological functions unknown. |
| 42 | Vanadium | No specific RDA. Aids in preventing heart attacks. Found in lower |
| | | organisms. |
| 43 | Tungsten | A number of enzymes (oxidoreductases) employ tungsten. |
| 44 | Zinc | Required for several enzymes. Helps prevent cancer. Boosts immunity. |
| | | Accelerates healing. |

TABLE 3
Example compositions of the present invention

| Ingredient | I | II | III |
|---|---|---|---|
| Water (ml) | 950 | 950 | 950 |
| Ionic Trace Minerals (grams) | 1.400 | 0.500 | 1.000 |
| Guarana 22% (grams) | 0.036 | 0.036 | 0.100 |
| Vitamin B12 (1%), (grams) | 0.040 | 0.090 | 0.010 |
| Green Tea Ext 50%, (grams) | 0.090 | 0.090 | 0.090 |
| Ascorbic Acid (grams) | 0.400 | 0.400 | 0.200 |
| Fructose (grams) | 26.500 | 13.000 | 0.000 |
| Sucrose (grams) | 0.000 | 13.500 | 26.500 |
| Citric Acid (grams) | 0.650 | 0.650 | 0.650 |
| Sodium Chloride (grams) | 0.400 | 0.200 | 0.400 |

What is claimed:

1. A fluid composition comprised of water, effective amounts of carbohydrates, trace minerals, and electrolytes to provide long-lasting energy, immediate nutritional health benefits, and improved athletic performance. The composition is comprised of essentially of the following ingredients:
a. From about 0.01 to 1.0% of a saturated ionic trace mineral solution
b. From about 0.5% to 25% of fructose, glucose, or sucrose, or a combination thereof comprising the same
c. From about 0.01% to 0.3% of additional sodium ions
d. Water

2. The fluid composition of claim 1 further comprising the following ingredients and ranges:
a. Guarana: 0.001-0.10%
b. Vitamin B12: 0.0001-0.1%
c. Green Tea Extract: 0.001-0.5%
d. Ascorbic Acid: 0.01-1.0%
e. Natural Flavoring: 0.01-10%
f. Citric Acid: 0.05-5.0%
g. Natural Coloring: 0.01-5.0%
